(19) United States
(12) Patent Application Publication
(10) Pub. No.: US 2025/0196905 A1
(43) Pub. Date: Jun. 19, 2025

(54) TRANSPORT DEVICE FOR OVERCOMING A STEP-LIKE OBSTACLE

(71) Applicant: Lucas Gerlach, Bad Salzungen (DE)

(72) Inventor: Lucas Gerlach, Bad Salzungen (DE)

(21) Appl. No.: 18/848,849

(22) PCT Filed: Mar. 20, 2023
(86) PCT No.: PCT/DE2023/100213

§ 371 Date: Sep. 19, 2024

(30) Foreign Application Priority Data
Mar. 25, 2022 (DE) 10 2022 107 154.5

(51) Int. Cl. B62B 5/02; B62B 1/12

(52) U.S. Cl. CPC B62B 5/026; B62B 1/12

(57) ABSTRACT

The present invention relates to a transport device (2) for overcoming a step-like obstacle (1), wherein the transport device (2) is movable in a traveling position and has a support structure (3) for supporting a load (4) to be transported. The task of the transport device (2) according to the invention is to overcome the difference in height of the step-like obstacle (1) by means of a leverage effect, whereby the transport device (2) should be usable on short stair steps. This task is accomplished in that via a tilting movement of the support structure (3) towards the step-like obstacle (1) a support element (10) of the transport device (2) can be set down on an upper surface (1a) of the step-like obstacle (1) and the support structure (3) can be tilted over the support element (10) set down in this way, and in that the transport device (2) has a connecting element (11), and in that the transport device (2) has a guide element (12) connected to the support structure (3), and in that the connecting element (11) is guided by the guide element (12), and in that the support element (10) is connected to the connecting element (11) in an articulated manner, and in that the connecting element (11) can be pivoted from a first into a second position relative to the support element (10) and brought from a first into a second position relative to the guide element (12), while the support structure (3) is supported against the upper surface (1a) of the step-like obstacle (1) via the support element (10).

The invention relates to a transport device for overcoming a step-like obstacle, wherein the transport device has a support element, and a support structure of the transport device can be supported on the step-like obstacle via the support element.

Among other devices, hand trucks are known for transporting objects. A hand truck of this type is described in DE 16 02 017 U, for example. This hand truck has a supporting frame formed by bars. Handles for pushing, pulling and steering the hand truck are attached to an upper end of the bars. A carrying element of the hand truck (often called a “nose” in the case of hand trucks), on which an object to be transported can be placed, is mounted at a lower end of the bars. Furthermore, in the area of the lower end of the bars, two wheels of the hand truck are rotatably mounted to the supporting frame. To move the hand truck, the bars are tilted around the axis of the wheels such that the supporting frame is fully supported on the wheels. By pushing or pulling on the handles, the supporting frame can then be moved on its wheels, possibly with an object placed on the carrying element. However, the disadvantage of such hand trucks is that steps impede the rolling of the wheels. It is almost impossible for the wheels to roll up conventional stair steps and it takes a great amount of effort to pull the aforementioned hand truck upwards.

Various designs for hand trucks and comparable transport devices intended to make it easier to overcome steps are known from the state of the art. There are known hand trucks with so-called “star wheels” instead of wheels. Hand trucks with so-called “skids” are also known. When using a hand truck with star wheels or skids, however, it is still necessary to pull the hand truck up steps, at least partially. This still requires a great amount of effort, especially when objects to be transported weigh more than 50 kg.

DE 88 05 642 U1 proposes a hand trolley that can be used on staircases. The hand trolley has a main frame (supporting frame) for carrying an object to be transported. A handle of the hand trolley for pushing, pulling and steering the hand trolley is attached to an upper end of the main frame. A carrier frame (nose), on which the object to be transported can be placed, is mounted at a lower end of the main frame. Furthermore, at the lower end of the main frame, two main wheels of the hand trolley are rotatably mounted to the main frame. The hand trolley can be driven like a hand truck. In addition, folding auxiliary wheels are provided on a lower part of the main frame, which protrude to the rear (towards the main wheels) when folded out. To overcome a (stair) step, the hand trolley is driven up to the step to be overcome until the main wheels are in contact with the vertical face of the step. In this position of the hand trolley, the folded-out auxiliary wheels point towards the step. By tilting the main frame towards the step, the folded-out auxiliary wheels are set down onto the horizontal face of the step. The main frame now forms a lever with its center of rotation in line with the axis of the folded-out auxiliary wheels. Starting from this position of the hand trolley, further tilting of the main frame towards the step causes the main wheels to raise. To overcome the step, the main wheels are raised until the main wheels (lower rolling surfaces of the main wheels) are at least at the level of the horizontal face of the step. By moving the hand trolley horizontally on the horizontal face of the step via the folded-out auxiliary wheels, the main wheels can then be moved onto the horizontal face of the step. The folded-out auxiliary wheels are therefore used as a lever device to raise the main wheels to the level of the horizontal face of the step by tilting the main frame. Additional pulling up is not necessary.

However, the hand trolley has the disadvantage that it cannot be used on short stair steps. This is because if a short stair step is followed by a next (higher) stair step, the main wheels and the folded-out auxiliary wheels cannot be positioned on the horizontal face of the short stair step at the same time due to the geometric conditions that then exist, which means that the main wheels cannot be moved onto the horizontal face of the short stair step. If the hand trolley were designed such that the folded-out auxiliary wheels were placed onto the horizontal face of the next stair step in order to raise the main wheels to the level of the horizontal face of the short stair step, the main wheels could be moved onto the horizontal face of the short stair step, but the hand trolley would then have the disadvantage that the main frame would have to be tilted very sharply to overcome the top step of a staircase. This is because the top step of a staircase is not followed by another stair step. Tilting the main frame very sharply to overcome the top step of a staircase would render the hand trolley unusable in practice.

The task of the invention is to create a transport device for overcoming a step-like obstacle, in which the difference in height of the step-like obstacle is overcome by means of a leverage effect, whereby the transport device should be usable on short stair steps.

This task is accomplished by a transport device with the characteristics according to claim 1. Advantageous embodiments of the transport device are found in dependent claims 2 to 30.

The transport device according to the invention is suitable for a wide range of applications. For example, it can be used when moving (house), transporting safes, transporting gas cylinders or transporting heavy printer equipment in office buildings.

Further advantageous characteristics of the transport device result from the exemplary embodiments, which are explained below with reference to the figures provided.

The figures are as follows:

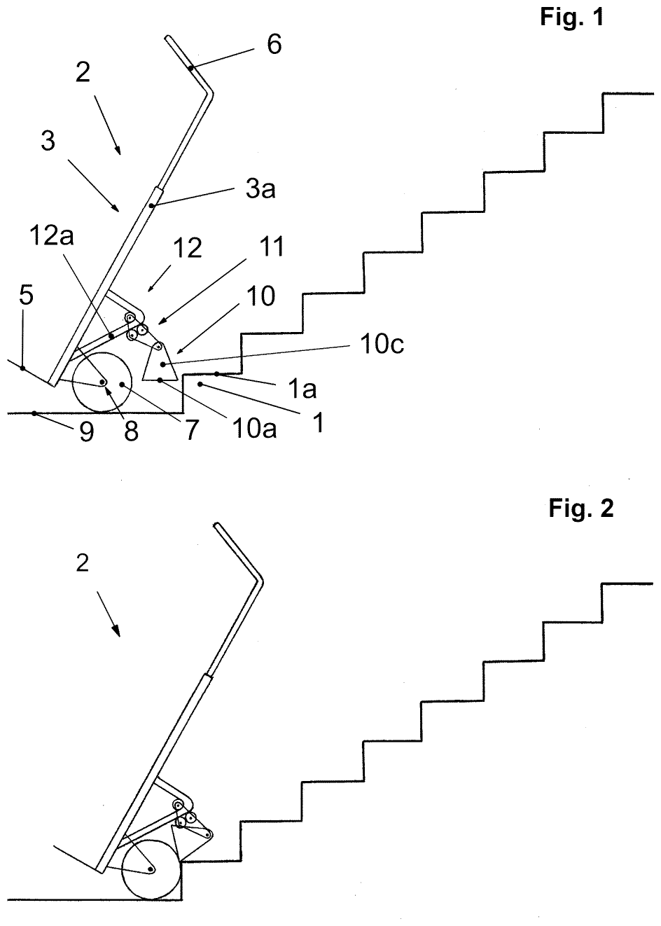

FIG. 1 to FIG. 14: a side view of an exemplary embodiment of the transport device according to the invention when overcoming a stair step;

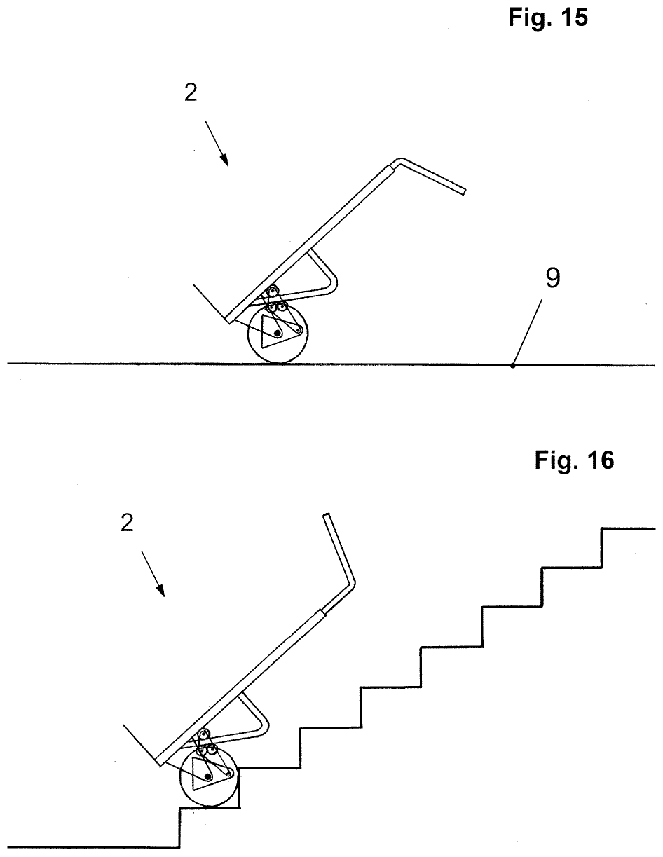

FIG. 15: a side view of the transport device according to FIG. 1 to FIG. 14 on a plane with a support element folded away and a handle element in a lower, rear position;

FIG. 16: a side view of the transport device according to FIG. 15 on a staircase with the handle element in a forward position;

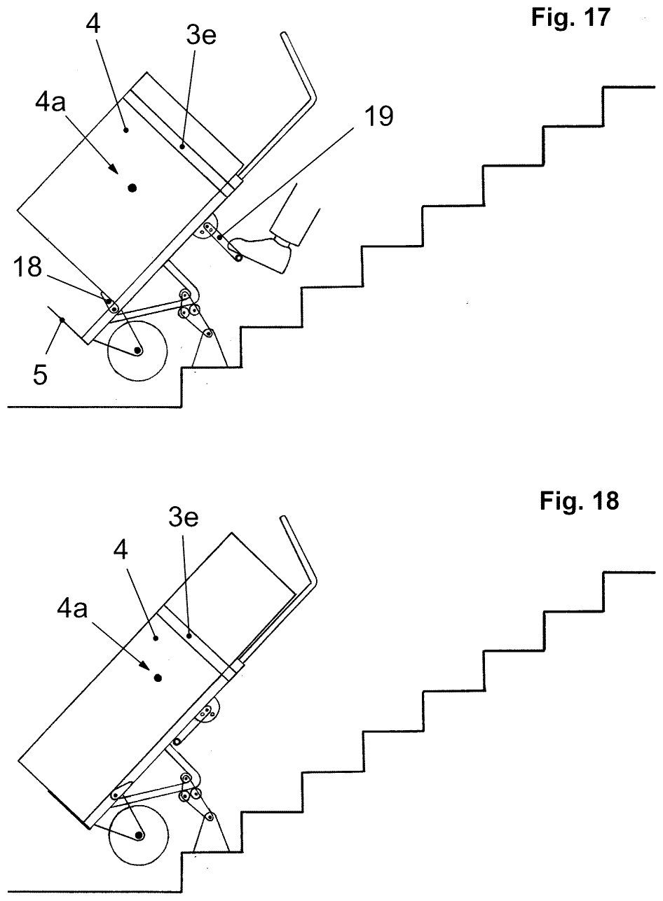

FIG. 17: a side view of a further exemplary embodiment of the transport device according to the invention with a rather low load to be transported, an additional load-bearing element and a pedal element;

FIG. 18: a side view of the transport device according to FIG. 17 with a rather tall load to be transported, the additional load-bearing element folded away and the pedal element folded away;

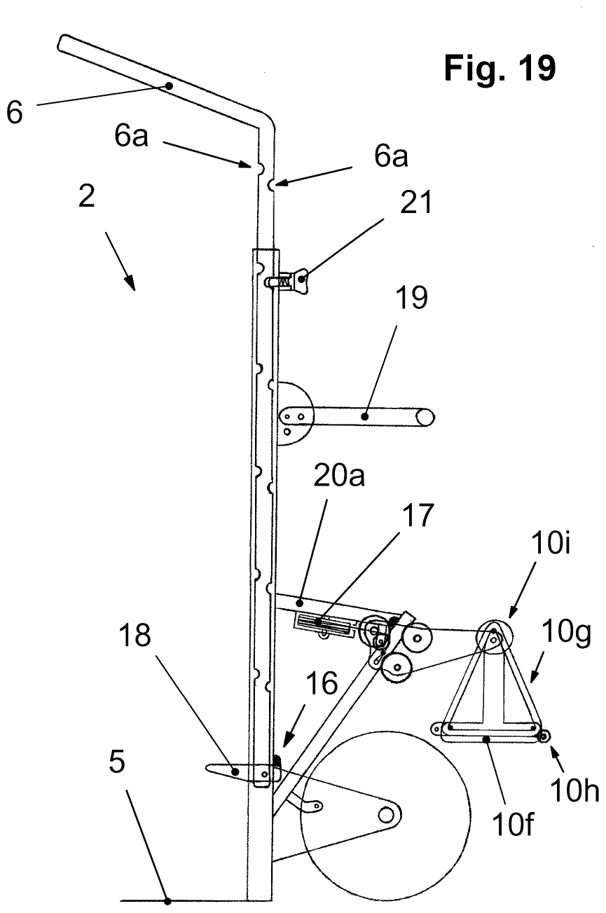

FIG. 19: a side view of the transport device according to FIG. 17 in a resting position with further details and the handle element in another forward position;

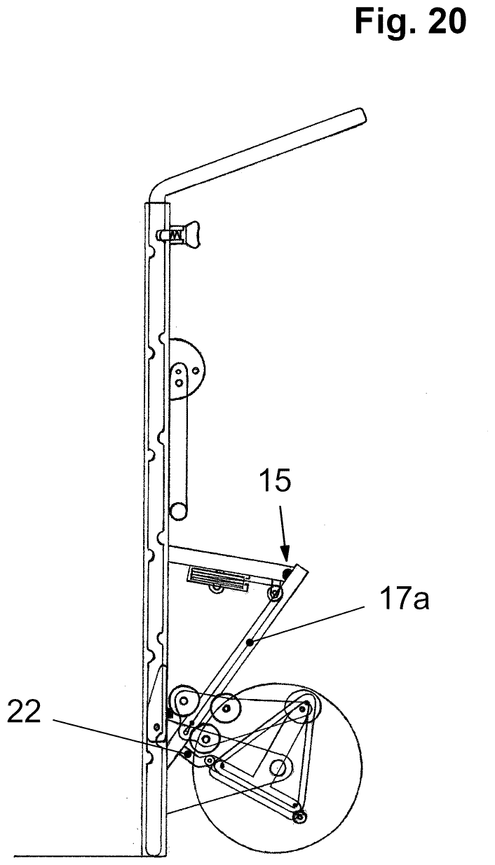

FIG. 20: a side view of the transport device according to FIG. 19 with the support element folded away, the additional load-bearing element folded away, the pedal element folded away and the handle element in its lower, rear position;

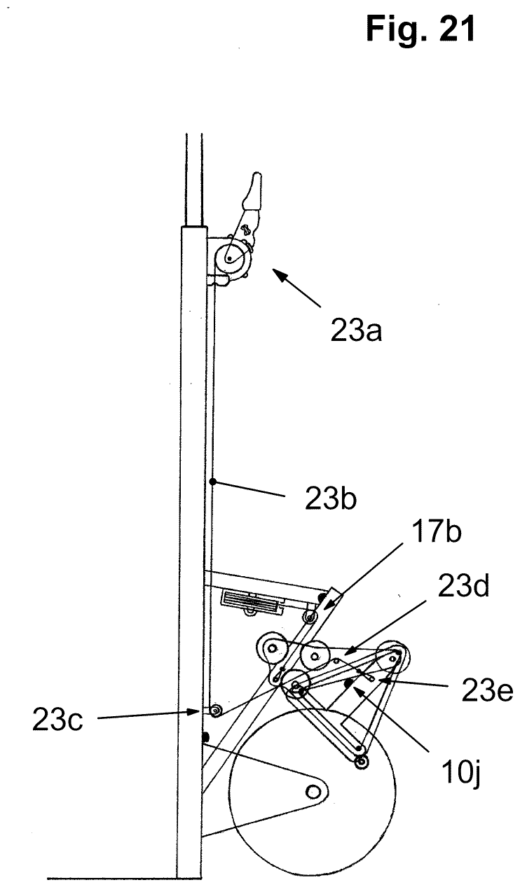

FIG. 21: a side view of a further exemplary embodiment of the transport device according to the invention in its resting position with a pulling mechanism for folding away the support element;

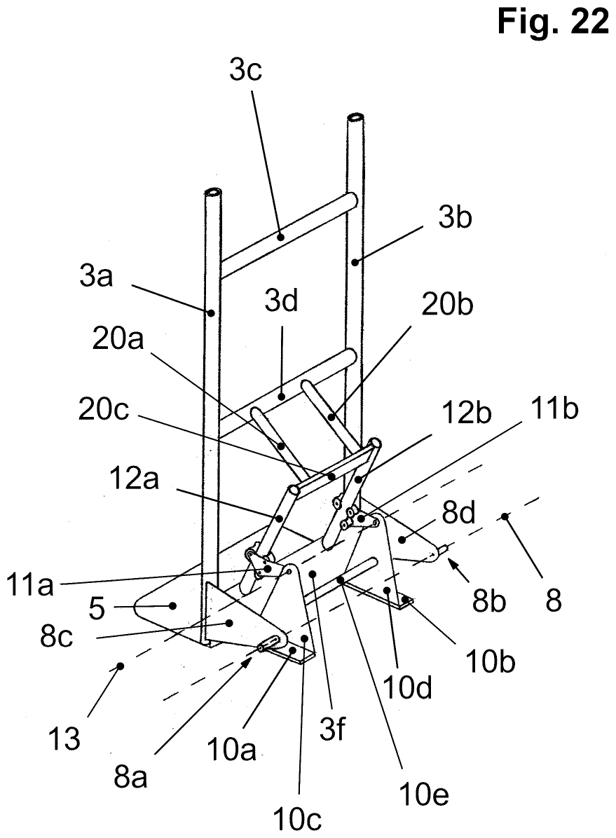

FIG. 22: a spatial representation of the support structure and other components of the transport device according to FIG. 1 to FIG. 21, as well as the guide element of the transport device according to FIG. 19 to FIG. 21;

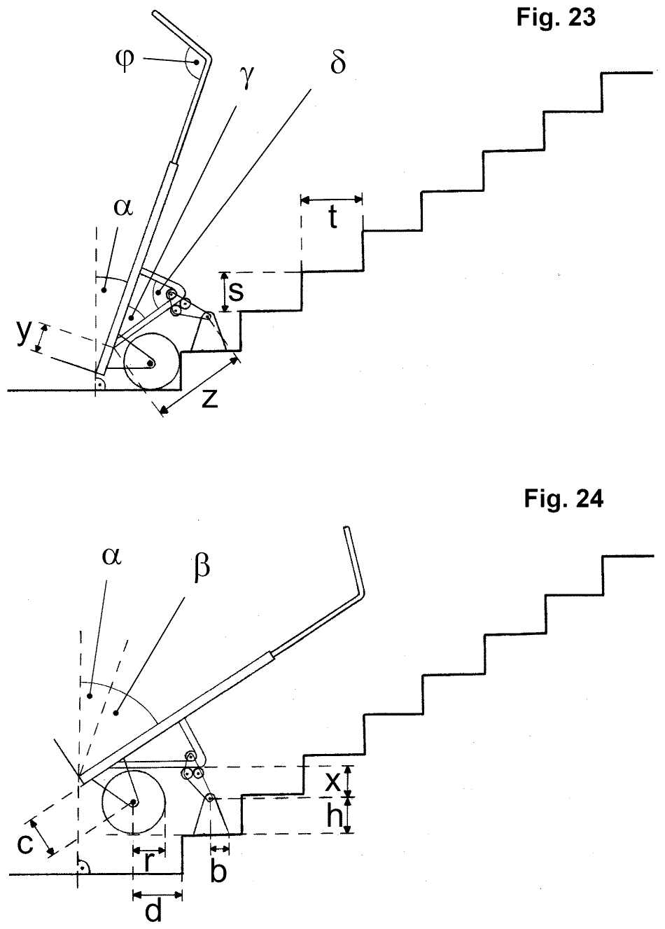

FIG. 23: a side view of the transport device according to FIG. 1 to FIG. 14 in its lower changeover position with relevant lengths and angles assigned;

FIG. 24: a side view of the transport device according to FIG. 1 to FIG. 14 in its lift-out position with relevant lengths and angles assigned;

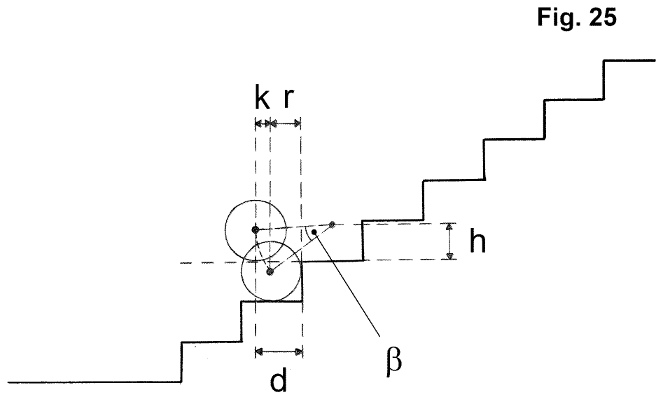

FIG. 25: in a side view, the minimum travel of the connecting element along the guide element for bringing the transport device from its lift-out position according to FIG. 6 into its upper changeover position according to FIG. 8; and

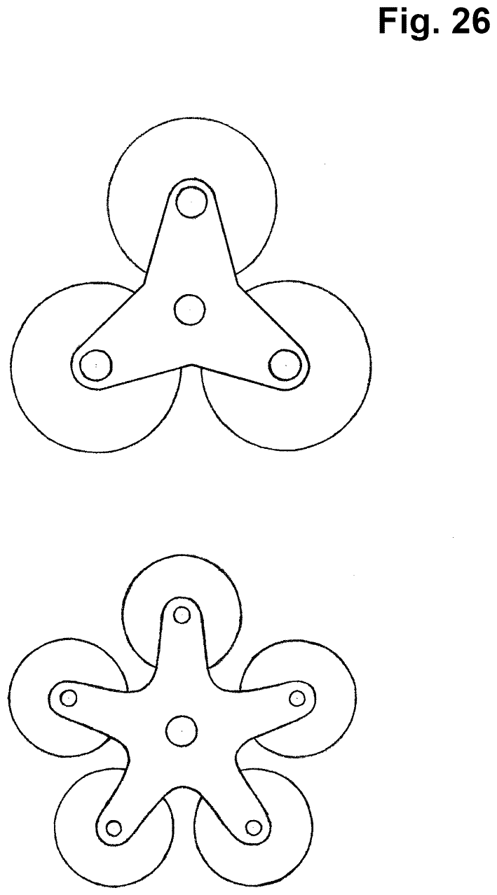

FIG. 26: in a side view, two exemplary embodiments of hubs to each of which multiple wheels are attached (star wheels).

FIG. 1 to FIG. 14 show a side view of the process of overcoming a step-like obstacle 1 with an exemplary embodiment of the transport device 2 according to the invention. Here, the step-like obstacle 1 is a stair step, but should be understood below as an umbrella term for various steps and step-shaped obstacles. The step-like obstacle 1 can therefore also be a curb, for example. The transport device 2 has a support structure 3 for supporting a load 4 to be transported (cf. FIG. 17 and FIG. 18). In the exemplary embodiment of the transport device 2 shown here, the support structure 3 comprises two longitudinal bars 3a and 3b (cf. FIG. 22), which are connected via two crossbars 3c and 3d (not visible here cf. FIG. 22), whereby only one (first) longitudinal bar 3a is visible here, since the other (second) longitudinal bar 3b is hidden by the (first) longitudinal bar 3a. However, the transport device 2 is not limited to such a support structure 3. In other embodiments of the transport device 2, the support structure 3 may, for example, be formed by only one or more than two longitudinal bars 3a and 3b and/or have no crossbars 3c and 3d and/or have other components. In the exemplary embodiment of the transport device 2 shown here, a load-bearing element 5 of the transport device 2 for picking up (and carrying) the load 4 to be transported is mounted at a lower end and on one side of the support structure 3. The load-bearing element 5 can be designed differently depending on the main type of load to be transported. In the exemplary embodiment of the transport device 2 shown here, it is designed as a flat sheet-metal element (cf. FIG. 22), which is arranged perpendicular to the longitudinal bars 3a and 3b. In the exemplary embodiment of the transport device 2 shown here, a handle element 6 of the transport device 2 for guiding the transport device 2 is attached to an upper end of the support structure 3. The handle element 6 is formed by two angled handles in the exemplary embodiment of the transport device 2 shown here, whereby only one (first) handle is visible here, since the other (second) handle is hidden by the (first) handle. In the exemplary embodiment of the transport device 2 shown here, the handles are designed as angled rods that are each inserted into the longitudinal bars 3a and 3b, respectively. However, the transport device 2 is not limited to such a handle element 6. In other embodiments of the transport device 2, the handle element 6 can be formed by just one handle, for example. In advantageous embodiments of the transport device 2, the handle element 6 is height-adjustable relative to the support structure 3 and/or adjustable between a rear position relative to the support structure 3 and a forward position relative to the support structure 3 and lockable in its various positions relative to the support structure 3.

A climbing element 7 of the transport device 2 is also mounted at the lower end of the support structure 3, which can advantageously be arranged on a side of the support structure 3 facing away from the load-bearing element 5. In the exemplary embodiment of the transport device 2 shown here, the climbing element 7 is formed by two rolling elements that can rotate around a rotational axle 8 of the transport device 2 and that are arranged at a distance from each other and are designed as wheels, on which the transport device 2 can be moved in a traveling position on a floor 9 in front of the step-like obstacle 1. Only one (first) wheel is visible here, since the other (second) wheel is hidden by the (first) wheel. However, the transport device 2 is not limited to a climbing element 7 designed in this way. In other embodiments of the transport device 2, the rolling elements can be hubs, for example, to each of which multiple wheels are attached (star wheels cf. FIG. 26). FIG. 1 shows the transport device 2 in its traveling position. In advantageous embodiments of the transport device 2, the transport device 2 has a backstop that can be activated and deactivated and that, when activated, makes the transport device 2 movable in only one direction. The backstop can, for example, be integrated into the climbing element 7, which is designed here as rolling elements, in such a way that when the backstop is activated, the rolling elements can only rotate in one direction in order to prevent the transport device 2 from unintentionally traveling down the step-like obstacle 1. In other advantageous embodiments of the transport device 2, the transport device 2 has a brake for braked descent from the step-like obstacle 1 and/or a shock absorber for shock-absorbed descent from the step-like obstacle 1.

The transport device 2 also has a support element 10, a connecting element 11, and a guide element 12 connected to the support structure 3, wherein the connecting element 11 is guided by the guide element 12 and is connected to the support element 10 in an articulated manner. The support element 10 can be pivoted relative to the connecting element 11 around a pivot axis 13 of the transport device 2. In the exemplary embodiment of the transport device 2 shown here, the support element 10 in the side view shown here (guided along the pivot axis 13) has a triangular outer contour and two supporting surfaces 10a and 10b, on which the support element 10 can be set down and which are arranged at a distance from the pivot axis 13 (cf. FIG. 22). The supporting surfaces 10a and 10b are each attached to one of two support parts 10c and 10d of the support element 10 (cf. FIG. 22) and connected to the connecting element 11 via the support parts 10c and 10d. Only a (first) supporting surface 10a and only a (first) support part 10c are visible here, since the other (second) supporting surface 10b and the other (second) support part 10d are hidden by the (first) supporting surface 10a and by the (first) support part 10c, respectively. In advantageous embodiments of the transport device 2, the support parts 10c and 10d are connected to each other via a transverse rod 10e. However, the transport device 2 is not limited to a support element 10 designed in this way. In other embodiments of the transport device 2, the support element 10 can, for example, have only one or more than two supporting surfaces 10a and 10b or can be formed by hubs arranged at a distance from one another that can rotate around the pivot axis 13, to each of which multiple wheels are attached (star wheels cf. FIG. 26). In the exemplary embodiment of the transport device 2 shown here, the guide element 12 is formed by two parallel and linear rail elements 12a and 12b (cf. FIG. 22) connected to the support structure 3. Only a (first) rail element 12a is visible here, since the other (second) rail element 12b is hidden by the (first) rail element 12a. The pivot axis 13 is arranged perpendicular to and at a distance from the rail elements 12a and 12b and parallel to the rotational axle 8 in the exemplary embodiment of the transport device 2 shown here. The connecting element 11 is guided along the rail elements 12a and 12b via a roller device of the connecting element 11 in the exemplary embodiment of the transport device 2 shown here, wherein the roller device is formed by two roller carriages 11a and 11b (cf. FIG. 22), the rollers of which each have a groove for receiving at least sections of the respectively assigned rail elements 12a and 12b. The roller carriages 11a and 11b in the exemplary embodiment of the transport device 2 shown here are designed such that the axles of their rollers each form a triangle in order to ensure that the connecting element 11 can only be moved along the rail elements 12a and 12b, but cannot be pivoted relative to the rail elements 12a and 12b. Only a (first) roller carriage 11a is visible here, since the other (second) roller carriage 11b is hidden by the (first) roller carriage 11a. The rail elements 12a and 12b in the exemplary embodiment of the transport device 2 shown here are advantageously angled relative to the longitudinal bars 3a and 3b, and attached to the support structure 3 on the side of the support structure 3 facing away from the load-bearing element 5. However, the transport device 2 is not limited to such a roller device or such rail elements 12a and 12b. In other embodiments of the transport device 2, the roller device can be formed by roller cages and/or ball cages, for example. The rail elements 12a and 12b can, for example, be not completely linear in other embodiments of the transport device 2. Furthermore, in other embodiments of the transport device 2, the guide element 12 can, for example, be formed by more than two rail elements 12a and 12b, and/or can be detachable from the support structure 3. In FIG. 1 to FIG. 14, the rail elements 12a and 12b (in contrast to the representations in FIG. 19 to FIG. 21) are shown as (linear) sections of angled rods and the grooved rollers of the roller device are not shown as overlapping the rail elements 12a and 12b, whereby in this context the representations in FIG. 1 to FIG. 14 can be regarded as simplifications of the representations in FIG. 19 to FIG. 21 and serve to improve clarity.

By a tilting movement of the support structure 3 towards the step-like obstacle 1, the support element 10 can be set down on an upper surface 1a of the step-like obstacle 1, and the transport device 2 can thereby be brought from its traveling position into a lower changeover position, wherein, in the lower changeover position of the transport device 2, the support structure 3 (preferably via the climbing element 7) is supported against the floor 9 and via the support element 10 against the upper surface 1a of the step-like obstacle 1. FIG. 4 shows the transport device 2 in its lower changeover position.

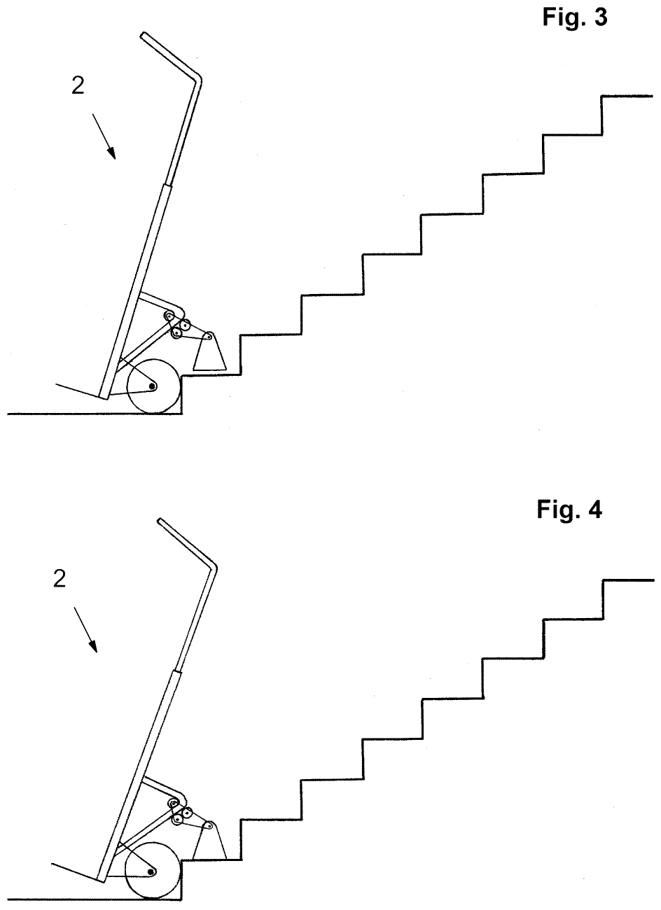

In the exemplary embodiment of the transport device 2 shown here, the support element 10 is advantageously designed such that, in order to bring the transport device 2 from its traveling position into its lower changeover position, the support element 10 in the traveling position of the transport device 2 can be pivoted around the pivot axis 13 towards the support structure 3 from an folded-out position relative to the connecting element 11 (cf. FIG. 1), corresponding to the lower changeover position of the transport device 2, into a folded-in position relative to the connecting element 11 (cf. FIG. 2). A support element 10 formed by star wheels that can rotate around the pivot axis 13 facilitates the transition of the transport device 2 from its traveling position into its lower changeover position thanks to the rotatability of the star wheels. Since, in the exemplary embodiment of the transport device 2 shown here, the support element 10 is mounted such that it can pivot around the pivot axis 13 in the traveling position of the transport device 2, it can swing (under the effect of gravity) from its folded-in position relative to the connecting element 11 in FIG. 2 into its folded-out position relative to the connecting element 11 in FIG. 3. Preferably, the support element 10 should have step-protecting components 10f, 10g, 10 h and 10i at its points of contact with the step-like obstacle 1 (cf. FIG. 19 to FIG. 21), which are made of a softer material compared to the material of the step-like obstacle 1. FIG. 2 and FIG. 3 show the transport device 2 during the transition from its traveling position into its lower changeover position.

In the lower changeover position of the transport device 2, the connecting element 11 is located in a first position relative to the support element 10. In a lift-out position of the transport device 2, the connecting element 11 is located in a second position relative to the support element 10. In order to bring the transport device 2 from its lower changeover position into its lift-out position, the connecting element 11 can be pivoted around the pivot axis 13 from its first position relative to the support element 10 into its second position relative to the support element 10, while the support structure 3 is supported against the upper surface 1a of the step-like obstacle 1 via the support element 10.

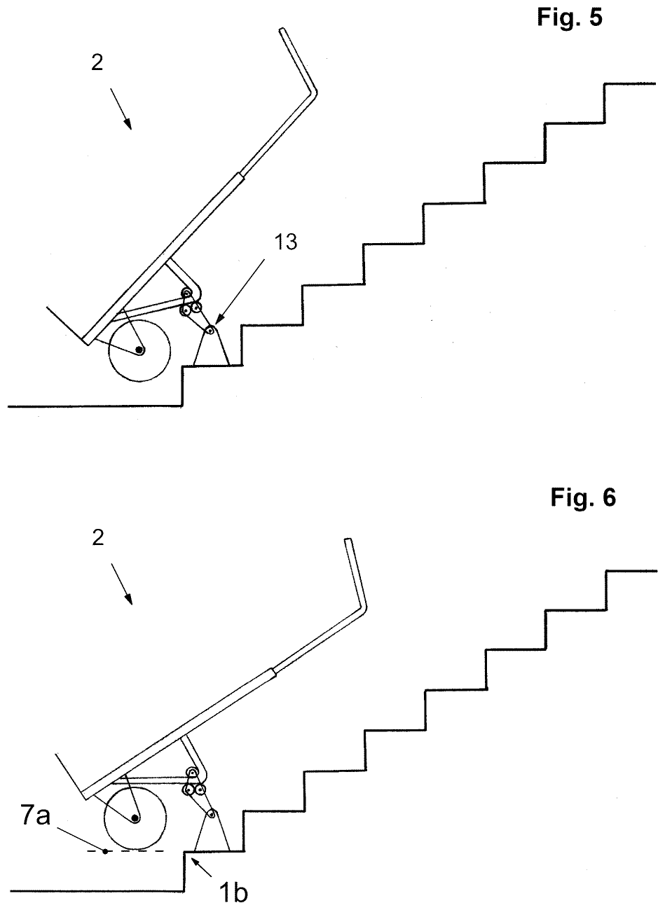

A further tilting movement of the support structure 3 towards the step-like obstacle 1, starting from the lower changeover position of the transport device 2, allows the support structure 3 to be tilted over the support element 10 in such a way that the climbing element 7 is raised and the transport device 2 can thereby be brought from its lower changeover position into its lift-out position (cf. FIG. 4 to FIG. 6), wherein, in the lift-out position of the transport device 2, the support structure 3 is supported against the upper surface 1a of the step-like obstacle 1 via the support element 10 and the climbing element 7 is raised relative to the floor 9. In FIG. 4 to FIG. 6, it can be seen that the support structure 3 serves as a lever for raising the climbing element 7 during this tilting movement, whereby in the exemplary embodiment of the transport device 2 shown here, the handle element 6, which is height-adjustable relative to the support structure 3, can additionally amplify this leverage effect. A horizontal rolling plane 7a of the rolling elements lying below the rotational axle 8, on which the rolling elements would be rollable in a non-lifted-out state, should advantageously be raised to or above the level of an upper edge 1b of the step-like obstacle 1 in the lift-out position of the transport device 2 (cf. FIG. 6). FIG. 6 shows the transport device 2 in its lift-out position. When bringing the transport device 2 from its lower changeover position into its lift-out position, the support element 10 is advantageously positioned stationary on the upper surface 1a of the step-like obstacle 1 in the exemplary embodiment of the transport device 2 shown here, because the support element 10 stands firmly on the upper surface 1a of the step-like obstacle 1 due to the weight of the support structure 3 and any load 4 resting on it. FIG. 5 shows the transport device 2 during the transition from its lower changeover position into its lift-out position.

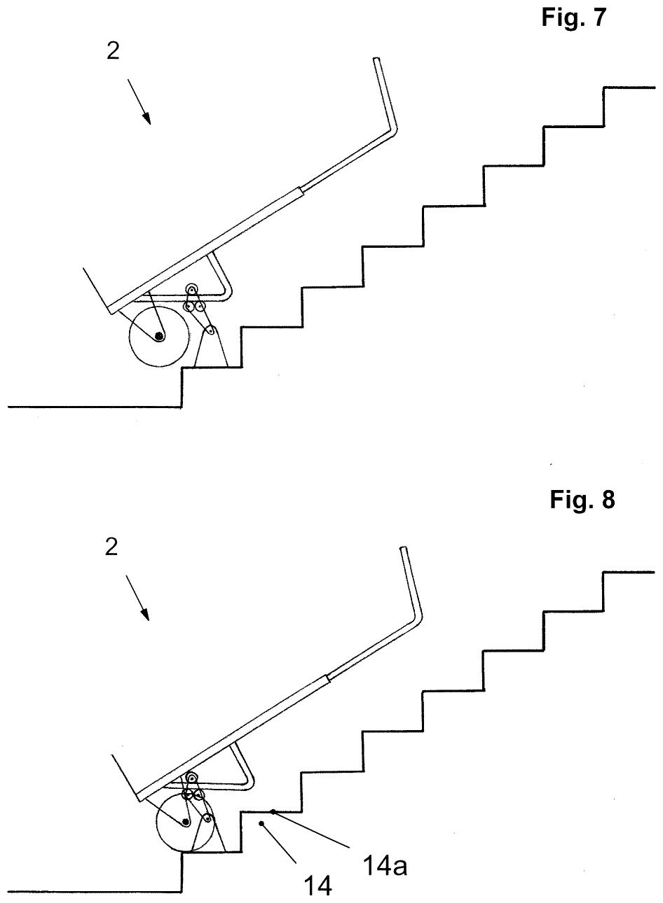

The transport device 2 can be brought from its lift-out position into an upper changeover position, wherein, in the upper changeover position of the transport device 2, the support structure 3 is supported against the upper surface 1a of the step-like obstacle 1 via the climbing element 7 and via the support element 10. In the exemplary embodiment of the transport device 2 shown here, in order to reach the upper changeover position of the transport device 2, the support structure 3 must be tilted so far over the support element 10 that the rolling plane 7a of the rolling elements in the lift-out position of the transport device 2 is raised at least to the level of the upper edge 1b of the step-like obstacle 1 (cf. FIG. 5 to FIG. 8). FIG. 8 shows the transport device 2 in its upper changeover position. When bringing the transport device 2 from its lift-out position into its upper changeover position, the support element 10, due to the weight of the support structure 3 and any load 4 resting on it, is also advantageously positioned stationary on the upper surface 1a of the step-like obstacle 1 in the exemplary embodiment of the transport device 2 shown here. FIG. 7 shows the transport device 2 during the transition from its lift-out position into its upper changeover position. In FIG. 6 to FIG. 8, it can be seen that, in the exemplary embodiment of the transport device 2 shown here, an essentially horizontal translational movement of the support structure 3 takes place in order to bring the transport device 2 from its lift-out position into its upper changeover position.

When bringing the transport device 2 from its lift-out position into its upper changeover position, the rail elements 12a and 12b should preferably be movable at least partially over a next upper surface 14a of a next step-like obstacle 14 following the step-like obstacle 1 and located higher than the step-like obstacle 1 (cf. FIG. 8). This means that the transport device 2 can be used on staircases, especially on staircases with short steps (cf. FIG. 1 to FIG. 14).

In the lift-out position of the transport device 2, the connecting element 11 is located in a first position relative to the guide element 12. In the upper changeover position of the transport device 2, the connecting element 11 is located in a second position relative to the guide element 12. In order to bring the transport device 2 from its lift-out position into its upper changeover position, the connecting element 11, guided by the guide element 12, can be brought from its first position relative to the guide element 12 into its second position relative to the guide element 12, while the support structure 3 is supported against the upper surface 1a of the step-like obstacle 1 via the support element 10.

The guide element 12 is designed as a linear guide in the exemplary embodiment of the transport device 2 shown here, whereby the rail elements 12a and 12b run along a plane and wherein the rail elements 12a and 12b become horizontally aligned when the transport device 2 is brought from its lower changeover position into its lift-out position.

The pivoting movement of the connecting element 11 around the pivot axis 13 from its first position relative to the support element 10 into its second position relative to the support element 10 should preferably be decoupled from the movement of the connecting element 11, guided by the guide element 12, from its first position relative to the guide element 12 into its second position relative to the guide element 12. The connecting element 11 in its first position relative to the guide element 12 can advantageously rest against a first mechanical stop 15 of the transport device 2 (cf. FIG. 20) and/or in its second position relative to the guide element 12 against a second mechanical stop 16 of the transport device 2 (cf. FIG. 19). In this way, movements of the connecting element 11, guided by the guide element 12, can be limited and thus, for example, the connecting element 11 can be held (under the effect of gravity) in its first position relative to the guide element 12 when bringing the transport device 2 from its lower changeover position into its lift-out position. As an alternative to the mechanical stops 15 and 16, the transport device 2 can have helical springs, for example, which are tensioned when the connecting element 11, guided by the guide element 12, is moved beyond its first position relative to the guide element 12 and/or beyond its second position relative to the guide element 12, in order to limit movements of the connecting element 11 guided by the guide element 12.

In order to bring the transport device 2 from its upper changeover position into its traveling position on the upper surface 1a of the step-like obstacle 1, the support structure 3 is tilted back such that the support element 10 lifts off the upper surface 1a of the step-like obstacle 1 and the support structure 3 is therefore no longer supported against the upper surface 1a of the step-like obstacle 1 via the support element 10. This allows the connecting element 11 to be brought back from its second position relative to the guide element 12 into its first position relative to the guide element 12.

In advantageous embodiments of the transport device 2, the transport device 2 has a restoring element for bringing the connecting element 11 from its second position relative to the guide element 12 into its first position relative to the guide element 12. The restoring element should preferably be designed such that, in the traveling position of the transport device 2, it provides a restoring force that exceeds the weight forces of the support element 10 and the connecting element 11 and acts on the connecting element 11, with which the connecting element 11 in the traveling position of the transport device 2 is moved from its second position relative to the guide element 12 into its first position relative to the guide element 12 and with which the connecting element 11 can be held in its first position relative to the guide element 12 in the traveling position of the transport device 2. The restoring element can, for example, comprise at least one helical spring and/or at least one gas spring and/or at least one spring balancer (known from the state of the art) 17 (cf. FIG. 19 to FIG. 21).

The transport device 2 can be moved in its traveling position on the upper surface 1a of the step-like obstacle 1.

Since, when bringing the connecting element 11 from its first position relative to the guide element 12 into its second position relative to the guide element 12, it is necessary to work against the restoring force of the restoring element, it may be advantageous, before bringing the connecting element 11 from its first position relative to the guide element 12 into its second position relative to the guide element 12, to tilt the support structure 3 even further over the support element 10 than in FIG. 6 in order to tip the rail elements 12a and 12b towards the step-like obstacle 1, and thus to benefit from the weight of the support structure 3 and any load 4 resting on it when bringing the connecting element 11 from its first position relative to the guide element 12 into its second position relative to the guide element 12.

If the step-like obstacle 1 is not followed by a next step-like obstacle 14, the connecting element 11 (together with the support element 10) can be brought unhindered from its second position relative to the guide element 12 into its first position relative to the guide element 12 when the support structure 3 is tilted back.

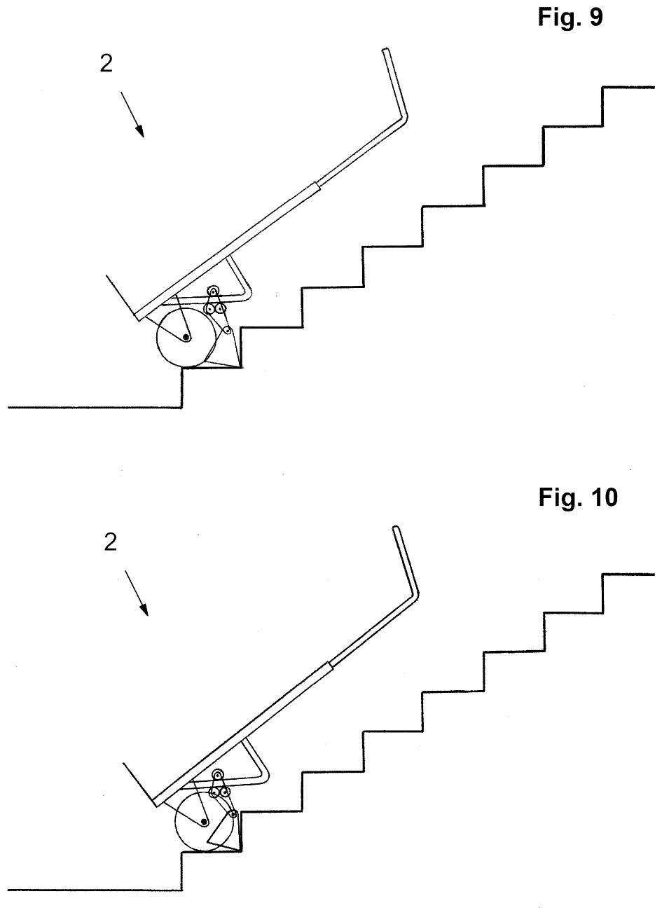

The representations in FIG. 1 to FIG. 14 show a staircase in which the step-like obstacle 1 is followed by the next step-like obstacle 14. Since the support element 10 can be pivoted into its folded-in position relative to the connecting element 11 when the transport device 2 is in its traveling position, the connecting element 11 can also be brought from its second position relative to the guide element 12 into its first position relative to the guide element 12 when the support structure 3 is tilted back, when the step-like obstacle 1 is followed by the next step-like obstacle 14, whereby the triangular outer contour of the support element 10, shown here, is advantageous (cf. FIG. 9 to FIG. 12). The pivoting movement of the support element 10 around the pivot axis 13 from its folded-out position relative to the connecting element 11 into its folded-in position relative to the connecting element 11 should preferably be decoupled from the movement of the connecting element 11, guided by the guide element 12, from its second position relative to the guide element 12 into its first position relative to the guide element 12. A support element 10 formed by star wheels that can rotate around the pivot axis 13 enables the connecting element 11 to be brought from its second position relative to the guide element 12 into its first position relative to the guide element 12 when tilting back the support structure 3, when the step-like obstacle 1 is followed by the next step-like obstacle 14, thanks to the rotatability of the star wheels.

In FIG. 13, the support element 10 is in its folded-out position relative to the connecting element 11. If, starting from this position of the transport device 2, the support structure 3 is tilted towards the next step-like obstacle 14, the support element 10 will be set down on the next upper surface 14a of the next step-like obstacle 14 (cf. FIG. 14). The support structure 3 will then be supported against the upper surface 1a of the step-like obstacle 1 via the climbing element 7 and against the next upper surface 14a of the next step-like obstacle 14 via the support element 10, whereby the transport device 2 will be in its lower changeover position on the step-like obstacle 1. FIG. 14 shows the transport device 2 in its lower changeover position on the step-like obstacle 1. Overcoming the next step-like obstacle 14 can be accomplished according to the aforementioned procedure for overcoming the step-like obstacle 1.

FIG. 15 shows a side view of the transport device 2 according to FIG. 1 to FIG. 14 on a flat surface (plane). Here, the support element 10 is in a folded-away position between the rolling elements, whereby the connecting element 11 is in its second position relative to the guide element 12 and the support element 10 is inclined towards the support structure 3. In the side view shown here, an outer contour of the support element 10 lies inside an outer contour of the climbing element 7, which is designed here as rolling elements. Advantageously, the transport device 2 can thus move on the floor 9 without the support element 10 causing any interference. The support element 10 should preferably be fixable in its folded-away position (cf. FIG. 19 and FIG. 20). The handle element 6 is located here in a lower, rear position relative to the support structure 3 to ensure a secure hold of the transport device 2 when moving on a flat surface.

FIG. 16 shows a side view of the transport device 2 according to FIG. 15 on a staircase. When the support element 10 is folded away, it does not collide with the stair steps when traveling up or down the staircase (without a load 4 or with a lightweight load 4 to be transported). The handle element 6 is located here in a forward position relative to the support structure 3 to ensure a secure hold of the transport device 2 when traveling up or down the staircase.

FIG. 17 shows a side view of a further exemplary embodiment of the transport device 2 according to the invention with a rather low load 4 to be transported. If this load 4 were placed on the load-bearing element 3 mounted at the lower end of the support structure 3, the load center of gravity 4a of this load 4 would be rather low relative to the pivot axis 13 in the lower changeover position of the transport device 2. As a result, when tilting the support structure 3 over the support element 10, a great amount of effort would be required to bring the transport device 2 from its lower changeover position into its lift-out position. Therefore, in the exemplary embodiment of the transport device 2 shown here, an additional load-bearing element 18 of the transport device 2 for picking up (and carrying) the load 4 to be transported is attached to the support structure 3 above the load-bearing element 5 on the side of the support structure 3 facing towards the load-bearing element 5. If the load 4 to be transported here is placed on the additional load-bearing element 18, its load center of gravity 4a shifts further upwards relative to the pivot axis 13, which reduces the effort required to bring the transport device 2 from its lower changeover position into its lift-out position. To reduce this effort, the exemplary embodiment of the transport device 2 shown here also has a pedal element 19 attached to the support structure 3 above the rail elements 12a and 12b on the side of the support structure 3 facing away from the load-bearing element 5 and thus facing the step-like obstacle 1. By pressing down the pedal element 19 with one foot when bringing the transport device 2 from its lower changeover position into its lift-out position, the aforementioned effort required (on the handle element 6) can be further reduced. Both the additional load-bearing element 18 and the pedal element 19 are advantageously designed to be foldable in the exemplary embodiment of the transport device 2 shown here, whereby the additional load-bearing element 18 is attached here between the longitudinal bars 3a and 3b. In other embodiments of the transport device 2, the additional load-bearing element 18 and the pedal element 19 can, for example, be designed to be suspended in the support structure 3 and/or to be height-adjustable relative to the support structure 3. Furthermore, in other embodiments, the transport device 2 can have several additional load-bearing elements and/or several pedal elements. The load 4 to be transported can, for example, be pulled onto and fixed on the additional load-bearing element 18 using a tensioning strap 3e, whereby the tensioning strap 3e can advantageously be attached to the support structure 3.

FIG. 18 shows a side view of the transport device 2 according to FIG. 17 with a rather tall load 4 to be transported, the additional load-bearing element 18 folded away and the pedal element 19 folded away. The load center of gravity 4a of this load 4 to be transported is higher relative to the pivot axis 13 than the load center of gravity 4a of the load 4 to be transported in FIG. 17, which means that the additional load-bearing element 18 and the pedal element 19 do not need to be used here.

FIG. 19 shows a side view of the transport device 2 according to FIG. 17 with further details. The transport device 2 is in a resting position here, whereby the transport device 2 in its resting position rests upright and is supported by the load-bearing element 5 and the climbing element 7. The handle element 6 is formed here by two handles designed as angled rods, each of which is inserted in sections into the longitudinal bars 3a and 3b, respectively. To lock the handle element 6 in a (here in another forward) position relative to the support structure 3, two locking bolts, that can engage in locking openings 6a of the aforementioned rods, are advantageously provided on the longitudinal bars 3a and 3b in the exemplary embodiment of the transport device 2 shown here. However, the transport device 2 is not limited to locking the handle element 6 in this way. Only a (first) locking bolt 21 is visible here, since the other (second) locking bolt is hidden by the (first) locking bolt 21.

Furthermore, the restoring element is shown, which is formed here by two spring balancers (known from the state of the art), whereby the spring balancers are each assigned to one of the roller carriages 11a and 11b. In the exemplary embodiment of the transport device 2 shown here, the spring balancers are each attached to one of two connecting bars 20a and 20b of the transport device 2 (cf. FIG. 22) that in turn are attached between the lower crossbar 3d and a (here not visible) cross connection 20c of the transport device 2 (cf. FIG. 22) between the rail elements 12a and 12b. However, the spring balancers do not necessarily have to be attached to the connecting bars 20a and 20b. In principle, they can also be attached at other points of the support structure 3, for example, whereby the tensioning cables of the spring balancers must then be guided to the roller carriages 11a and 11b around idlers of the restoring element. In the illustration shown here, the tensioning cables of the spring balancers are also connected to the respective roller carriages 11a and 11b and previously guided around idlers. In advantageous embodiments of the transport device 2, the roller carriages 11a and 11b are rigidly connected to each other, whereby the tensioning cables of the spring balancers can then advantageously be coupled to this rigid connection between the roller carriages 11a and 11b. Only a (first) spring balancer 17 and only a (first) tensioning cable 17a and only a (first) idler 17b are visible here, since the other (second) spring balancer and the other (second) tensioning cable and the other (second) idler are hidden by the (first) spring balancer 17 and by the (first) tensioning cable 17a and by the (first) idler 17b, respectively. The same applies to the representations in FIG. 20 and FIG. 21.

The connecting element 11 is located here in its first position relative to the guide element 12 and rests against the first mechanical stop 15. In the exemplary embodiment of the transport device 2 shown here, the first mechanical stop 15 is mounted on the rail elements 12a and 12b and the second mechanical stop 16 is attached to the support structure 3, whereby the second mechanical stop 16 also serves here as a stop for the additional load-bearing element 18. However, the transport device 2 is not limited to such mechanical stops 15 and 16. In other embodiments of the transport device 2, for example, both mechanical stops 15 and 16 can be attached to the rail elements 12a and 12b.

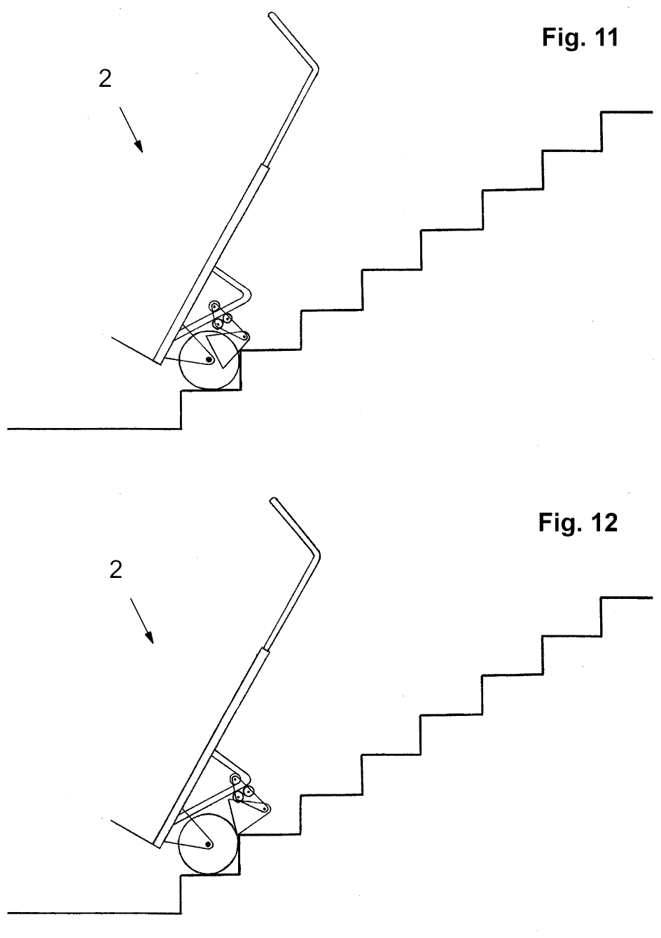

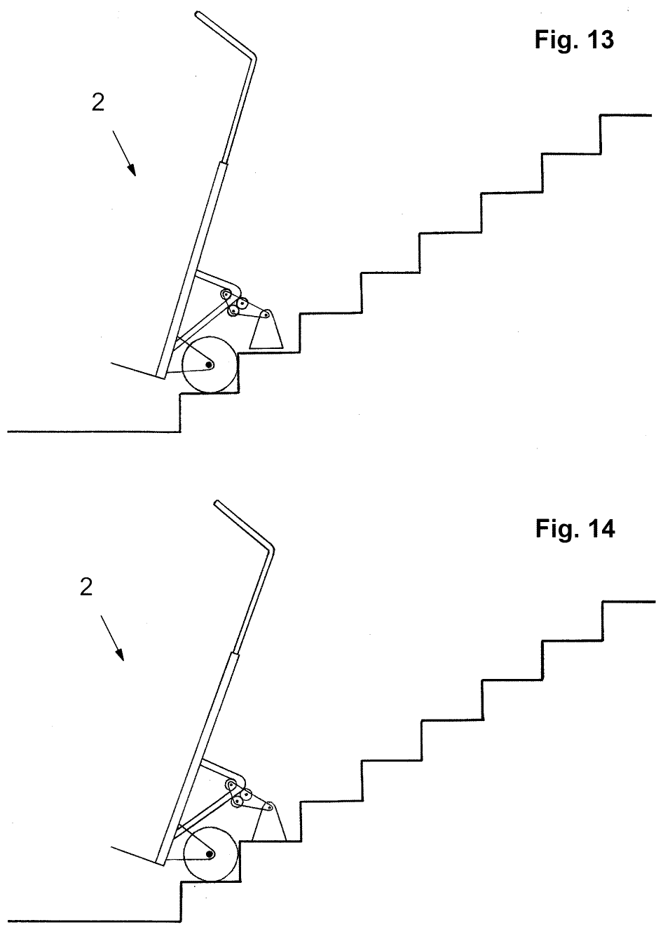

The side view of the support element 10 shows its triangular outer contour. Furthermore, the aforementioned step-protecting components 10f, 10g, 10 h and 10i of the support element 10 are shown here. The lower side of the support element 10, on which the support element 10 can be set down (cf. FIG. 22), advantageously has a rubber sole 10f to improve the stability of the support element 10 and to prevent damage to the step-like obstacle 1 (cf. FIG. 4 to FIG. 8). The (here) right-hand side of the support element 10 also advantageously has a rubberization to prevent damage to the step-like obstacle 1 (cf. FIG. 11), whereby this rubberization is designed as a tensioned rubber belt 10g, tensioned on the support element 10 in the illustration shown here. Instead of this rubberization, a foam layer can be used in other embodiments of the transport device 2, for example. A lower rubber wheel 10h is advantageously attached to the (here) lower, right-hand corner of the support element 10 in order to prevent damage to the step-like obstacle 1 (cf. FIG. 2, FIG. 9, FIG. 10 and FIG. 12). In addition, an upper rubber wheel 10i is advantageously attached to the upper corner of the support element 10 in order to prevent damage to the step-like obstacle 1 (cf. FIG. 10 and FIG. 11). The part of the support element 10 visible here with the step-protecting components 10f, 10g, 10 h and 10i can, for example, be implemented in duplicate and thus be regarded as a possible embodiment of the two support elements 10c and 10d in FIG. 22.

FIG. 20 shows a side view of the transport device 2 according to FIG. 19, whereby both the additional load-bearing element 18 and the pedal element 19 are folded away compared to the illustration in FIG. 19. In addition, the support element 10 is in its folded-away position, whereby in the exemplary embodiment of the transport device 2 shown here, it can be fixed in its folded-away position by a locking element 22 of the transport device 2. The tensioning cables of the spring balancers are extended here and thus tensioned such that the aforementioned restoring force acts on the connecting element 11. The support element 10 is moved manually into its folded-away position in the exemplary embodiment of the transport device 2 shown here. The handle element 6 is located here in its lower, rear position relative to the support structure 3 (cf. FIG. 15).

FIG. 21 shows a side view of a further exemplary embodiment of the transport device 2 according to the invention, wherein the transport device 2 here has a pulling mechanism (operable in an upper region of the support structure 3) for bringing the support element 10 into its folded-away position. Such a pulling mechanism makes it possible to change direction with the transport device 2 on a staircase, for example. In the exemplary embodiment of the transport device 2 shown here, the pulling mechanism comprises a pulling device 23a, a pulling element 23b, a lower idler 23c and an upper idler 23d, whereby one end of the pulling element 23b is attached to the support element 10 and the pulling element 23b is guided from this connection, initially around the upper idler 23d attached to the connecting element 11 and then around the lower idler 23c, here attached to the support structure 3, to the pulling device 23a. When the pulling device 23a is actuated, the pulling element 23b is pulled in towards the pulling device 23a and the support element 10 is pivoted (folded) towards the support structure 3, until a mechanical pivot stop 10j of the support element 10 strikes the connecting element 11. When the pulling element 23b is pulled in further towards the pulling device 23a, the connecting element 11 (together with the folded support element 10) is pulled from its first position relative to the guide element 12 into its second position relative to the guide element 12. With the connecting element 11 in its second position relative to the guide element 12, the folded support element 10 is in its folded-away position. The pulling device 23a can be attached to the upper crossbar 3c, for example. Since the pulling element 23b could sag in the upper changeover position of the transport device 2 when the transport device 2 is used according to the invention, automatic tightening of the pulling element 23b can be advantageous. Such automatic tightening of the pulling element 23b can be achieved, for example, by an automatic belt tensioner with retraction function (automatic tensioning strap as known from the state of the art), in which the pulling element 23b (belt) is (automatically) wound up by the pulling device 23a even without actuation of the pulling device 23a when the retraction function is permanently activated. The pulling force of the pulling device 23a when the retraction function is permanently activated should be dimensioned so that, in the traveling position of the transport device 2, a (gravity-induced) swinging of the support element 10 from its folded-in position relative to the connecting element 11 into its folded-out position relative to the connecting element 11 is ensured. In this context, it is also advantageous to position the point of action 23e of the pulling element 23b on the support element 10 as close as possible to the pivot axis 13 in order to minimise the torque from the pulling element 23b acting on the support element 10. For reasons of clarity, the additional load-bearing element 18, the pedal element 19, the (first) locking bolt 21 and an upper part of the handle element 6 are not shown here.

FIG. 22 shows a spatial representation of the support structure 3 and other components of the transport device 2 according to FIG. 1 to FIG. 21 and the guide element 12 of the transport device 2 according to FIG. 19 to FIG. 21. The climbing element 7 formed by two wheels is not shown here for reasons of clarity, which means that two rotational-axle stubs 8a and 8b are visible, which in turn are connected to the support structure 3 via rotational-axle mountings 8c and 8d. Based on this spatial representation, it can be seen that in the exemplary embodiment of the transport device 2 shown here, the support element 10 can be advantageously placed between the rolling elements, whereby the support element 10 can be positioned between the rolling elements in its folded-away position and in the upper changeover position of the transport device 2. However, the transport device 2 is not limited to such an embodiment. In other embodiments of the transport device 2, for example, the rolling elements can be positioned between the support parts 10c and 10d in the upper changeover position of the transport device 2. This spatial representation also shows that the rail elements 12a and 12b are attached to a transverse plate 3f, which in turn is arranged between the longitudinal bars 3a and 3b in the exemplary embodiment of the transport device 2 shown here.

The components of the transport device 2 should be dimensioned such that the transport device 2 can be used on staircases without a stair tread overhang and with a step height s (length of the vertical faces of the stair steps) of 21 cm and a step depth t (length of the horizontal faces of the stair steps) of 21 cm. With such a design, the transport device 2 can be used for most common stair step dimensions.

FIG. 23 and FIG. 24 show the relevant dimensions of the components of the transport device 2 (lengths and angles). In FIG. 23, the transport device 2 according to FIG. 4 is shown in its lower changeover position. In FIG. 24, the transport device 2 according to FIG. 6 is shown in its lift-out position. The tilting angle α is the angle by which the support structure 3 must be tilted in order to bring the transport device 2 from its resting position into its lower changeover position. The tilting angle β is the angle by which the support structure 3 must be tilted over the support element 10 in order to bring the transport device 2 from its lower changeover position into its lift-out position. The radius r of the rolling elements, here implemented as wheels, determines the attachment height of the rotational axle 8 relative to the longitudinal bars 3a and 3b. The height h of the support element 10 is the distance from the pivot axis 13 to the supporting surfaces 10a and 10b and thus to the upper surface 1a of the step-like obstacle 1 when the support element 10 is set down on it. The height h of the support element 10 should not be too small, as otherwise the tilting angle β of the support structure 3 would be too large, which would mean that the transport device 2 could not be used on steep staircases. A sufficiently large height h of the support element 10 and a pivot axis 13 that is thus sufficiently spaced from the upper surface 1a of the step-like obstacle 1 can significantly reduce the tilting angle β of the support structure 3 (cf. FIG. 25). This is a further advantageous feature of the transport device 2 according to the invention compared to the state of the art. However, if the height h of the support element 10 is too large, this has a negative effect on its stability when set down. A height h of the support element 10 and a width b of the support element 10 should be used, at which a small tilting angle β of the support structure 3 and at the same time good stability of the support element 10 on the step-like obstacle 1 are ensured. The width b of the support element 10 in FIG. 24 refers here only to the right-hand part of the symmetrically designed support element 10, since the width b of the right-hand part of the support element 10 is here more relevant for the use of the transport device 2 according to the invention than the width of the left-hand part of the support element 10. In practice, a height h of the support element 10 of approximately 16 cm and a width b of the support element 10 of approximately 8 cm have proven to be favorable. If the angle γ of the rail elements 12a and 12b relative to the longitudinal bars 3a and 3b is too large, it would be unnecessarily difficult to tilt the support structure 3 over the support element 10 in the lower changeover position of the transport device 2 (a too small). If the angle γ is too small, the tilting angle β of the support structure 3 would be too large. In practice, an angle γ of approximately 35° has proven to be favorable. In advantageous embodiments of the transport device 2, the angle γ is adjustable. The angle q between the handle element 6, formed here by angled handles, and the longitudinal bars 3a and 3b should enable ergonomically favorable handling of the transport device 2 on staircases. To ensure that the transport device 2 is held securely in its lift-out position, the angle q should not be too large. However, the angle q should also not be so small as to make it unnecessarily difficult to tilt the support structure 3 over the support element 10 in the lower changeover position of the transport device 2. In practice, an angle q of approximately 110° has proven to be favorable. The angle δ of the connecting bars 20a and 20b relative to the rail elements 12a and 12b should advantageously be less than 90°, so that the transport device 2 can also be used on staircases with a stair tread overhang. The distance x is the distance between the pivot axis 13 and the rail elements 12a and 12b and must be greater than the step height s minus the height h of the support element 10. The linear rail elements 12a and 12b should ideally be longer than the distance d (cf. FIG. 25). The distance c is the distance between the rotational axle 8 and the longitudinal bars 3a and 3b. The mounting height y of the rail elements 12a and 12b relative to the support structure 3 (or relative to the transverse plate 3f according to FIG. 22) depends on the distance c. If the distance c is too small, the mounting height y is too high, which means that the rail elements 12a and 12b could damage a higher stair step when the transport device 2 is in its upper changeover position. A too large distance c would make it unnecessarily difficult to tilt the longitudinal bars 3a and 3b to bring the transport device 2 from its resting position into its traveling position. In practice, favorable values for the distance c and the mounting height y can be found depending on the radius r of the wheels. If the aforementioned lengths and angles are known, the distance z is determined in the lower changeover position of the transport device 2 according to FIG. 23.

FIG. 25 shows a side view of the distance d (minimum travel) by which the connecting element 11 must at least be movable along the guide element 12 in order to bring the transport device 2 from its lift-out position according to FIG. 6 into its upper changeover position according to FIG. 8. It can be seen that the distance d is composed of the radius r of the rolling elements, implemented here as wheels, and a tilting distance k resulting from the tilting movement of the support structure 3 over the support element 10. Consequently, the distance d depends on the distance between the rotational axle 8 and the pivot axis 13 in the lower changeover position of the transport device 2 and on the tilting angle β of the support structure 3 for bringing the transport device 2 from its lower changeover position into its lift-out position.

FIG. 26 shows a side view of two embodiments of the aforementioned hubs to each of which multiple wheels are attached (star wheels) and which can be used both as a climbing element 7 and as a support element 10.

The transport device 2 can be designed, for example, as a hand truck, in particular as a stacking truck, tire truck, barrel truck, package truck, bottle truck, plate truck, trash-can transport truck, sack truck, chair truck or equipment truck.

### LIST OF REFERENCE SIGNS

1 step-like obstacle
1a upper surface
1b upper edge
2 transport device
3 support structure
3a, 3b longitudinal bars
3c, 3d crossbars
3e tensioning strap
3f transverse plate
4 load
4a load center of gravity
5 load-bearing element
6 handle element
6a locking openings
7 climbing element
7a rolling plane
8 rotational axle
8a, 8b rotational-axle stubs
8c, 8d rotational-axle mountings
9 floor
10 support element
10a, 10b supporting surfaces
10c, 10d support parts
10e transverse rod
10f rubber sole
10g tensioned rubber belt
10h lower rubber wheel
10i upper rubber wheel
10j mechanical pivot stop
11 connecting element
11a, 11b roller carriages
12 guide element
12a, 12b rail elements
13 pivot axis
14 next step-like obstacle
14a next upper surface
15 first mechanical stop
16 second mechanical stop
17 spring balancer
17a tensioning cable
17b idler
18 additional load-bearing element
19 pedal element
20a, 20b connecting bars
20c cross connection
21 locking bolt
22 locking element
23a pulling device
23b pulling element
23c lower idler
23d upper idler
23e point of action

1. Transport device (2) for overcoming a step-like obstacle (1), wherein the transport device (2) has a support structure (3) for supporting a load (4) to be transported, and wherein a climbing element (7) of the transport device (2) is attached to a lower end of the support structure (3), and wherein the transport device (2) can be moved in a traveling position on a floor (9) in front of the step-like obstacle (1), and wherein via a tilting movement of the support structure (3) towards the step-like obstacle (1) a support element (10) of the transport device (2) can be set down on an upper surface (1a) of the step-like obstacle (1) and the transport device (2) can thereby be brought from its traveling position into a lower changeover position, and wherein in the lower changeover position of the transport device (2) the support structure (3) is supported against the floor (9) and via the support element (10) against the upper surface (1a) of the step-like obstacle (1), and wherein via a further tilting movement of the support structure (3) towards the step-like obstacle (1) starting from the lower changeover position of the transport device (2) the support structure (3) can be tilted over the support element (10) in such a way that the climbing element (7) is raised and the transport device (2) can thereby be brought from its lower changeover position into a lift-out position, and wherein in the lift-out position of the transport device (2) the support structure (3) is supported against the upper surface (1a) of the step-like obstacle (1) via the support element (10) and the climbing element (7) is raised relative to the floor (9), and wherein the transport device (2) can be brought from its lift-out position into an upper changeover position, and wherein in the upper changeover position of the transport device (2) the support structure (3) is supported against the upper surface (1a) of the step-like obstacle (1) via the climbing element (7) and via the support element (10), and wherein the transport device (2) on the step-like obstacle (1) can be brought from its upper changeover position into its traveling position, and wherein the transport device (2) in its traveling position can be moved on the upper surface (1a) of the step-like obstacle (1), characterised in that the transport device (2) has a connecting element (11), and in that the transport device (2) has a guide element (12) connected to the support structure (3), and in that the connecting element (11) is guided by the guide element (12), and in that the support element (10) is connected to the connecting element (11) in an articulated manner, and in that in the lower changeover position of the transport device (2) the connecting element (11) is located in a first position relative to the support element (10), and in that in the lift-out position of the transport device (2) the connecting element (11) is located in a second position relative to the support element (10), and in that, in order to bring the transport device (2) from its lower changeover position into its lift-out position, the connecting element (11) can be pivoted around a pivot axis (13) of the transport device (2) from its first position relative to the support element (10) into its second position relative to the support element (10), while the support structure (3) is supported against the upper surface (1a) of the step-like obstacle (1) via the support element (10), and in that in the lift-out position of the transport device (2) the connecting element (11) is located in a first position relative to the guide element (12), and in that in the upper changeover position of the transport device (2) the connecting element (11) is located in a second position relative to the guide element (12), and in that, in order to bring the transport device (2) from its lift-out position into its upper changeover position, the connecting element (11) can be brought from its first position relative to the guide element (12) into its second position relative to the guide element (12), while the support structure (3) is supported against the upper surface (1a) of the step-like obstacle (1) via the support element (10).

2. Transport device (2) according to claim 1, characterised in that the climbing element (7) is formed by two rolling elements that can rotate around a rotational axle (8) of the transport device (2) and that are arranged at a distance from each other and on which the transport device (2) can be moved in its traveling position and/or via which the support structure (3) is supported against the floor (9) in the lower changeover position of the transport device (2).

3. Transport device (2) according to claim 2, characterised in that the rolling elements are wheels, or in that the rolling elements are hubs to each of which multiple wheels are attached.

4. Transport device (2) according to one of the claim 2 or 3, characterised in that in the lift-out position of the transport device (2) a horizontal rolling plane (7a) of the rolling elements lying below the rotational axle (8), on which the rolling elements would be rollable in a non-lifted-out state, is raised to or above the level of an upper edge (1b) of the step-like obstacle (1).

5. Transport device (2) according to one of the aforementioned claims, characterised in that the connecting element (11) in its first position relative to the guide element (12) rests against a first mechanical stop (15) of the transport device (2), and/or in that the connecting element (11) in its second position relative to the guide element (12) rests against a second mechanical stop (16) of the transport device (2).

6. Transport device (2) according to one of the aforementioned claims, characterised in that the guide element (12) is detachable from the support structure (3).

7. Transport device (2) according to one of the aforementioned claims, characterised in that the pivoting movement of the connecting element (11) from its first position relative to the support element (10) into its second position relative to the support element (10) is decoupled from the movement of the connecting element (11), guided by the guide element (12), from its first position relative to the guide element (12) into its second position relative to the guide element (12).

8. Transport device (2) according to one of the aforementioned claims, characterised in that the support element (10) has at least one supporting surface (10a, 10b) arranged at a distance from the pivot axis (13) and on which the support element (10) can be set down, and/or in that the support element (10) is positioned stationary on the upper surface (1a) of the step-like obstacle (1) when the transport device (2) is brought from its lower changeover position into its lift-out position and/or when the transport device (2) is brought from its lift-out position into its upper changeover position.

9. Transport device (2) according to claim 8, characterised in that the support element (10) has a triangular outer contour in a view oriented along the pivot axis (13).

10. Transport device (2) according to claim 9, characterised in that the support element (10) has step-protecting components (10f, 10g, 10 h, 10i) that are made of a softer material compared to the material of the step-like obstacle (1).

11. Transport device (2) according to one of the aforementioned claims, characterised in that, in order to bring the transport device (2) from its traveling position into its lower changeover position, the support element (10) in the traveling position of the transport device (2) can be pivoted around the pivot axis (13) towards the support structure (3) from a folded-out position relative to the connecting element (11), corresponding to the lower changeover position of the transport device (2), into a folded-in position relative to the connecting element (11).

12. Transport device (2) according to claim 11, characterised in that the pivoting movement of the support element (10) from its folded-out position relative to the connecting element (11) into its folded-in position relative to the connecting element (11) is decoupled from a movement of the connecting element (11), guided by the guide element (12), from its second position relative to the guide element (12) into its first position relative to the guide element (12).

13. Transport device (2) according to one of the aforementioned claims, characterised in that in the traveling position of the transport device (2) the support element (10) is mounted to swing around the pivot axis (13).

14. Transport device (2) according to one of the claims 1 to 7, characterised in that the support element (10) is formed by hubs that can rotate around the pivot axis (13) and that are arranged at a distance from one another and to each of which multiple wheels are attached.

15. Transport device (2) according to one of the aforementioned claims, characterised in that the transport device (2) has a restoring element for bringing the connecting element (11) from its second position relative to the guide element (12) into its first position relative to the guide element (12).

16. Transport device (2) according to claim 15, characterised in that the restoring element comprises at least one helical spring and/or at least one gas spring and/or at least one spring balancer (17).

17. Transport device (2) according to one of the claims 2 to 16, characterised in that in the upper changeover position of the transport device (2) the support element (10) is positioned between the rolling elements.

18. Transport device (2) according to one of the claims 2 to 17, characterised in that the transport device (2) has a pulling mechanism (23) for bringing the support element (10) into a folded-away position between the rolling elements, and/or in that the support element (10) can be fixed in its folded-away position via a locking element (22) of the transport device (2).

19. Transport device (2) according to claim 18, characterised in that the pulling mechanism (23) comprises at least one automatic belt tensioner with retraction function.

20. Transport device (2) according to one of the aforementioned claims, characterised in that the guide element (12) comprises at least two parallel rail elements (12a, 12b) connected to the support structure (3), and in that the connecting element (11) is guided along the rail elements (12a, 12b) via a roller device of the connecting element (11).

21. Transport device (2) according to claim 20, characterised in that the roller device comprises rollers, in particular grooved rollers, and/or roller cages and/or ball cages.

22. Transport device (2) according to one of the claim 20 or 21, characterised in that the guide element (12) is designed as a linear guide and the rail elements (12a, 12b) run along a plane, and in that the rail elements (12a, 12b) become horizontally aligned when the transport device (2) is brought from its lower changeover position into its lift-out position.

23. Transport device (2) according to one of the claims 20 to 22, characterised in that the rail elements (12a, 12b) can be moved at least partially over a next upper surface (14a) of a next step-like obstacle (14) following the step-like obstacle (1) and located higher than the step-like obstacle (1) when the transport device (2) is brought from its lift-out position into its upper changeover position.

24. Transport device (2) according to one of the claim 22 or 23, characterised in that the pivot axis (13) is arranged perpendicular to and at a distance from the rail elements (12a, 12b) and parallel to the rotational axle (8).

25. Transport device (2) according to claim 24, characterised in that the support structure (3) comprises at least one longitudinal bar (3a, 3b), and in that a load-bearing element (5) of the transport device (2) for picking up the load (4) to be transported is mounted at the lower end and on one side of the support structure (3), and in that the climbing element (7) is mounted at the lower end and on one side of the support structure (3) facing away from the load-bearing element (5), and in that a handle element (6) of the transport device (2) for guiding the transport device (2) is attached to an upper end of the support structure (3), and in that on the side of the support structure (3) facing away from the load-bearing element (5) the rail elements (12a, 12b) are attached to the support structure (3) at an angle to the at least one longitudinal bar (3a, 3b).

26. Transport device (2) according to one of the aforementioned claims, characterised in that the transport device (2) has a backstop that can be activated and deactivated and that, when activated, makes the transport device (2) movable in only one direction.

27. Transport device (2) according to one of the aforementioned claims, characterised in that the transport device (2) has a brake for braked descent from the step-like obstacle (1) and/or a shock absorber for shock-absorbed descent from the step-like obstacle (1).

28. Transport device (2) according to one of the claims 25 to 27, characterised in that the handle element (6) is height-adjustable relative to the support structure (3) and/or adjustable between a rear position relative to the support structure (3) and a forward position relative to the support structure (3), and/or in that the handle element (6) is formed by at least one angled rod.

29. Transport device (2) according to one of the claims 25 to 28, characterised in that at least one pedal element (19) of the transport device (2) for tilting the support structure (3) is attached to the support structure (3) on the side of the support structure (3) facing away from the load-bearing element (5) and/or above the load-bearing element (5) at least one additional load-bearing element (18) of the transport device (2) for picking up the load (4) to be transported is attached to the support structure (3) on the side of the support structure (3) facing towards the load-bearing element (5).

30. Transport device (2) according to one of the aforementioned claims, characterised in that the transport device (2) is designed as a hand truck, in particular as a stacking truck, tire truck, barrel truck, package truck, bottle truck, plate truck, trash-can transport truck, sack truck, chair truck or equipment truck.
